(19) United States
(12) Patent Application Publication
(10) Pub. No.: US 2013/0034085 A1
(43) Pub. Date: Feb. 7, 2013

(54) Medium Access Control Timing Advance Group Assignment

(71) Applicants: Lisa Boström, Solna (SE); Robert Baldemair, Solna (SE); Mattias Bergström, Kista (SE); Magnus Stattin, Sollentuna (SE)

(72) Inventors: Lisa Boström, Solna (SE); Robert Baldemair, Solna (SE); Mattias Bergström, Kista (SE); Magnus Stattin, Sollentuna (SE)

(21) Appl. No.: 13/204,404

(22) Filed: Aug. 5, 2011

(51) Int. Cl. H04J 3/00

(52) U.S. Cl. 370/336

(57) ABSTRACT

In a method for assigning serving cells of a mobile terminal to timing advance groups, a network node transmits a Medium Access Control (MAC) control element to a mobile terminal in a wireless communication network. The MAC control element includes a set of first indicators, with each first indicator specifying whether a corresponding serving cell of the mobile terminal is to be included in a timing advance group. The MAC control element also includes at least one second indicator, with each second indicator specifying a timing advance group, and also specifying, via a defined mapping, the serving cell of the mobile terminal to which the timing advance group corresponds.

### TECHNICAL FIELD

The present invention generally relates to timing advance groups, and more particularly relates to grouping serving cells of a network node into timing advance groups for uplink carrier aggregation.

### BACKGROUND

Release 10 of the Long Term Evolution (LTE) specifications from the 3rd Generation Partnership Project (3GPP) has recently been standardized, and among its features is support for component carrier bandwidths up to 20 MHz. However, in order to meet the International Mobile Telecommunications Advanced (IMT-Advanced) requirements for very high data rates, the concept of carrier aggregation has been introduced to support bandwidths larger than 20 MHz. The carrier aggregation concept is illustrated in FIG. 1, where five component carriers 10 are illustrated, with respective component carrier bandwidths of f1, f2, f3, f4 and f5. In the example of FIG. 1, the total bandwidth available to a mobile terminal is the sum of the component carrier bandwidths.

The number of aggregated component carriers, as well as the bandwidth for each individual component carrier, may be different for uplink and downlink operation. A symmetric configuration refers to the case where the number of component carriers in downlink and uplink is the same, while an asymmetric configuration refers to the case where the number of component carriers is different.

LTE Release 10 supports the activation and the configuration of component carriers, so that component carriers may be configured using Radio Resource Control (RRC) signaling, which can be slow, and can be activated using a Medium Access Control (MAC) control element, which is much faster. Since the activation process is based on MAC control elements—which are much faster than RRC signaling—an activation/de-activation process can quickly adjust the number of activated component carriers to match the number that are required to fulfill data rate needs at any given time. Activation therefore provides the possibility to keep multiple component carriers configured for activation on an as-needed basis.

LTE Release 10 utilizes single carrier frequency division multiple access (SC-FDMA) in the uplink (UL), and in order to preserve orthogonality in the uplink (UL), transmissions from multiple mobile terminals may need to be time aligned at the base station. That is, since mobile terminals may be located at different distances from the base station, the mobile terminals may need to initiate their UL transmissions at different times. A timing advance defined by the base station instructs the mobile terminals to start their UL transmissions earlier or later than a default transmission time to achieve the desired time alignment.

In LTE Release 10, the component carriers (i.e. serving cells) aggregated by a mobile terminal are denoted primary cell (PCell) and secondary cells (SCells). Each mobile terminal has a single PCell and has a plurality of SCells. The PCell is always activated, but the SCells can be selectively activated/deactivated using an octet of a MAC control element. The term “cell” in this regard refers to the intersection of a defined carrier frequency and a particular geographic region. LTE Release 10 only supports a single UL timing advance value for each mobile terminal, so that each activated UL cell of the mobile terminal has the same timing advance value. More recently, it has been proposed to include mobile terminal cells in timing advance groups having a variety of timing advance values.

### SUMMARY

In a method for assigning serving cells of a mobile terminal to timing advance groups, a network node transmits a Medium Access Control (MAC) control element to a mobile terminal in a wireless communication network. The MAC control element includes a set of first indicators, with each first indicator specifying whether a corresponding serving cell of the mobile terminal is to be assigned to a timing advance group. The MAC control element also includes at least one second indicator, with each second indicator specifying a timing advance group, and also specifying, via a defined mapping, the serving cell of the mobile terminal to which the timing advance group corresponds.

A corresponding network node configured to assign one or more serving cells of a mobile terminal to one or more timing advance groups includes a communication interface configured to send signals to the mobile device and to receive signals from the mobile device. The network node also includes one or more processing circuits operatively associated with the communication interface that are configured to transmit, via the communication interface, a MAC control element that includes a set of first indicators, with each first indicator specifying whether a corresponding serving cell of the mobile terminal is to be assigned to a timing advance group. The MAC control element also includes at least one second indicator, with each second indicator specifying a timing advance group, and also specifying, via a defined mapping, the serving cell of the mobile terminal to which the timing advance group corresponds.

In another method for assigning one or more serving cells of a mobile terminal to one or more timing advance groups, a network node transmits a MAC control element to a mobile terminal in a wireless communication network. A subheader associated with the MAC control element includes a logical channel identifier (LCID). The network node indicates all activated secondary serving cells of the mobile terminal as being assigned to a timing advance group of the primary serving cell of the network node by setting said LCID to include one of a first plurality of LCID values. The network node indicates secondary serving cells of the mobile terminal identified by a first octet of the MAC control element as being assigned to timing advance groups identified in one or more second octets of the MAC control element by setting said LCID to include one of a second plurality of LCID values.

A corresponding network node configured to assign one or more serving cells of a mobile terminal to one or more timing advance groups includes a communication interface configured to send signals to the mobile device and to receive signals from the mobile device. The network node also includes one or more processing circuits operatively associated with the communication interface that are configured to transmit, via the communication interface, a MAC control element and an associated subheader. The subheader includes a logical channel identifier (LCID). The one or more processing circuits are configured to indicate all activated secondary serving cells of the mobile terminal as being assigned to a timing advance group of the primary serving cell of the network node by setting the LCID to include one of a first plurality of LCID values. The one or more processing circuits are configured to indicate secondary serving cells of the mobile terminal identified by a first octet of the MAC control element as being assigned to timing advance groups identified in one or more second octets of the MAC control element by setting said LCID to include one of a second plurality of LCID values.

In a method implemented by a mobile terminal for determining timing advance group assignments for one or more serving cells, the mobile terminal receives a MAC control element from a network node, with the MAC control element comprising a set of first indicators and at least one second indicator. The mobile terminal determines whether its serving cells are to be included in a timing advance group based the first indicator corresponding to each serving cell. The mobile terminal determines a timing advance group assignment of each second indicator, the timing advance group assignment indicating a timing advance group, and also indicating, via a defined mapping, the serving cell of the mobile terminal to which the timing advance group assignment corresponds.

A corresponding mobile terminal operative to determine timing advance group assignments received from a network node in a wireless communication network includes a communication interface configured to send signals to a network node and to receive signals from the network node, and one or more processing circuits operatively associated with said communication interface. The processing circuits are configured to receive, via the communication interface, a Medium Access Control (MAC) control element from the network node, the MAC control element comprising a set of first indicators and at least one second indicator. The processing circuits are also configured to determine whether serving cells of the mobile terminal are to be included in a timing advance group based on each serving cell's corresponding first indicator, and determine a timing advance group assignment of each second indicator. The timing advance group assignment indicates a timing advance group, and also indicates, via a defined mapping, the serving cell of the mobile terminal to which the timing advance group assignment corresponds.

In another method for determining timing advance group assignments for one or more serving cells, a mobile terminal receives a MAC control element and an associated subheader from a network node, with the subheader including a LCID. The mobile terminal includes all of its activated secondary serving cells in a timing advance group of its primary serving cell responsive to said LCID including one of a first plurality of LCID values. The mobile terminal includes secondary serving cells identified by a set of first indicators of the MAC control element in timing advance groups identified in one or more second indicators of the MAC control element responsive to said LCID including one of a second plurality of LCID values. The mobile terminal includes one or more processing circuits configured to carry out these steps.

A corresponding mobile terminal operative to determine timing advance group assignments received from a network node in a wireless communication network includes a communication interface configured to send signals to a network node and to receive signals from the network node, and one or more processing circuits operatively associated with said communication interface. The processing circuits are configured to receive, via the communication interface, a Medium Access Control (MAC) control element and an associated subheader from a network node, the subheader including a logical channel identifier (LCID). The processing circuits are configured to include all activated secondary serving cells of the mobile terminal in a timing advance group of the primary serving cell of the mobile terminal responsive to said LCID including one of a first plurality of LCID values. The processing circuits are also configured to include secondary serving cells of the mobile terminal identified by a set of first indicators of the MAC control element in timing advance groups identified in one or more second indicators of the MAC control element responsive to said LCID including one of a second plurality of LCID values.

In one or more embodiments, the quantity of first indicators indicating inclusion in a timing advance group is equal to the quantity of second indicators, and the defined mapping comprises an association between an ordering of the first and second indicators in which, for example, the second indicators are arranged in the same order as their corresponding first indicators.

In one or more embodiments, the first indicators may also be used, for example, to specify whether a corresponding serving cell is to be activated or should remain activated for use in uplink carrier aggregation. In one or more embodiments, the first indicators are located in an octet of their MAC control element, and other non-first indicator bits of the octet can be used to communicate timing advance group information.

Of course, the present invention is not limited to the above features and advantages. Indeed, those skilled in the art will recognize additional features and advantages upon reading the following detailed description, and upon viewing the accompanying drawings.

### BRIEF DESCRIPTION OF THE DRAWINGS

FIG. 1 illustrates the aggregation of multiple carriers in a known system that employs carrier aggregation.

FIG. 2 schematically illustrates a wireless communication network having mobile terminals located at varying distances in relation to a base station.

FIG. 3 is a downlink and uplink signaling diagram of the wireless communication network of FIG. 2.

FIG. 4 is a block diagram of an example wireless communication network configured to implement both carrier aggregation and timing advance groups.

FIGS. 5-9 illustrate a plurality of example signaling arrangements for communicating timing advance group assignment information.

FIGS. 10a-b illustrate a plurality of example LCID values for use in connection with the signaling arrangement of FIG. 9.

### DETAILED DESCRIPTION

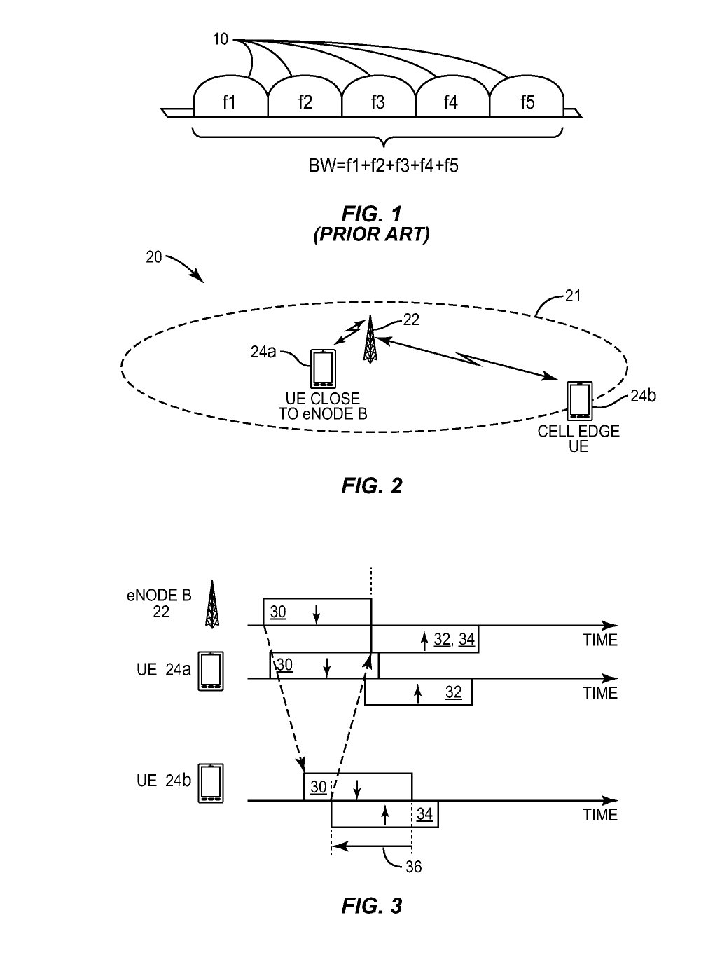

Referring to the drawings, FIG. 2 illustrates a wireless communication network 20 in which a network node 22 (e.g., a base station, known as an “eNodeB” in LTE networks) communicates with mobile terminals 24a-b (e.g., user equipment “UE” of an LTE network) located at varying distances in relation to the network node 22. As shown in FIG. 2, the first mobile terminal 24a is closer in proximity to the network node 20 than the second mobile terminal 24b, as the second mobile terminal 24b is located at an edge of a cell 21 of the network 20. In view of this distance variation, uplink (UL) signals transmitted by the closer mobile terminal 24a may arrive at the network node 22 sooner than uplink signals transmitted by the further mobile terminal 24b.

FIG. 3 is a downlink and uplink signaling diagram of the wireless communication network 20 of FIG. 2 that incorporates a timing advance. As shown in FIG. 3, a downlink signal 30 from the network node 22 first arrives at mobile terminal 24a, and then subsequently arrives at mobile terminal 24b, introducing a delay for uplink signal 34 from the mobile terminal 24b. To reduce this delay and enable the uplink signals 32, 34 from the mobile terminals 24a-b to arrive at approximately the same time, a timing advance 36 is introduced for the mobile terminal 24b, so that transmission of the uplink signal 34 is initiated earlier than transmission of uplink signal 32. By using the timing advance 36, the uplink signals 32, 34 can be closely time-aligned at the network node 22, and orthogonality in the uplink can be preserved.

Referring again to the carrier aggregation component carriers 10 of FIG. 1, if selected ones of the component carrier bandwidths (i.e., f1, f2, f3, f4, f5) are being used for carrier aggregation in the uplink, it may be desirable to assign timing advances to those aggregated carriers by using a timing advance group such that the aggregated component carriers have the same timing advance value.

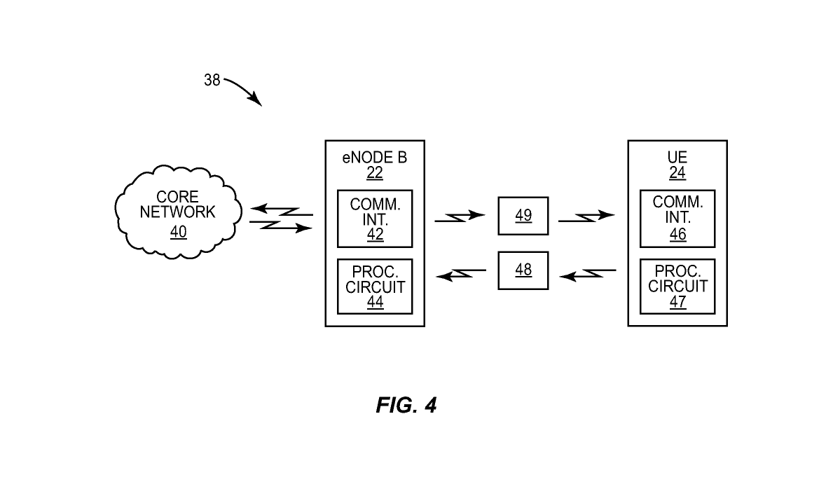

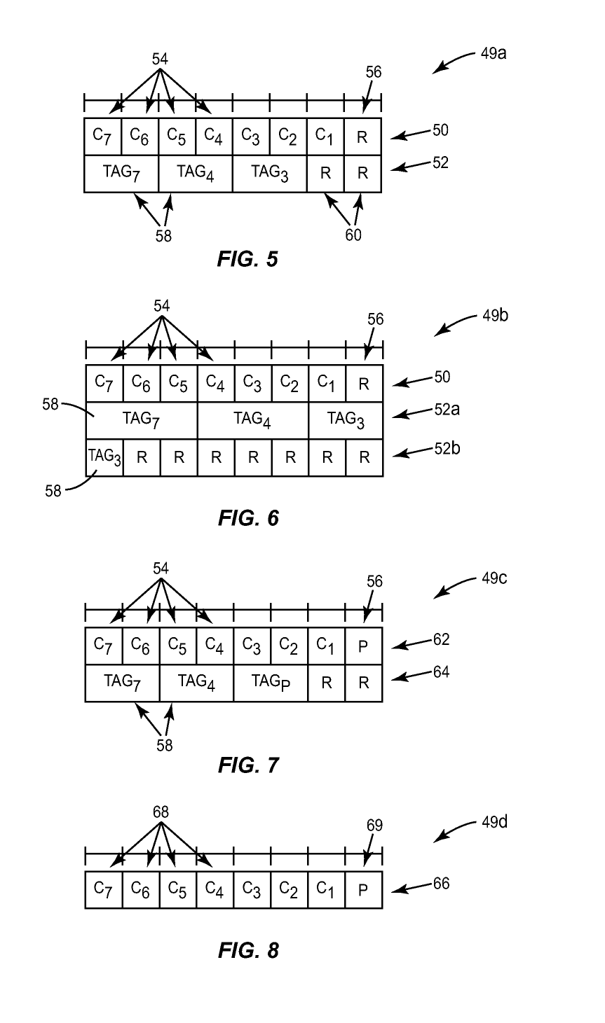

FIG. 4 is a block diagram of an example wireless communication network 38 configured to implement carrier aggregation and timing advance groups, using the signaling arrangements of FIGS. 5-9. The wireless communication network 38 includes a core network 40, a network node 22, and one or more mobile terminals 24. The network node 22 includes a communication interface 42 including one or more transceivers configured to transmit messages between the mobile terminal 24 and the core network 40. For example, the one or more transceivers of interface 42 are configured to transmit MAC control elements 49 to the mobile terminals 24, and to receive carrier aggregated uplink data 48 from the mobile terminal 24. The network node 22 also includes one or more processing circuits 44 operatively associated with the communication interface 42, and configured to perform a number of control features. For example, the processing circuits 44 are configured to transmit, via the communication interface 42, MAC control elements to assign one or more serving cells of the mobile terminal 24 to timing advance groups so that the one or more serving cells share the timing advance values of their respective timing advance groups.

The mobile terminal 24 similarly includes a communication interface 46 and one or more processing circuits 47. The communication interface 46 includes one or more transceivers configured to receive messages from the network node 22, and transmit messages to the network node 22. The one or more processing circuits 47 are operatively associated with the communication interface 46, and are configured to perform a number of communication features, including determining timing advance group assignments from signaling received from the network node 22, and based on those received assignments including selected serving cells in selected timing advance groups.

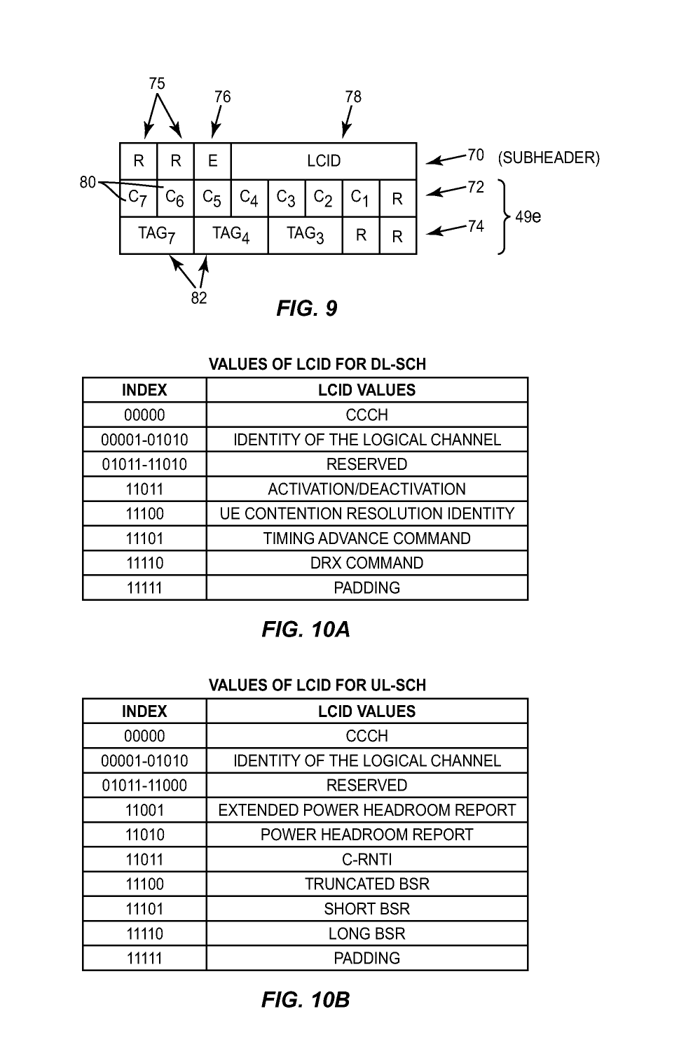

FIGS. 5-9 illustrate a plurality of example signaling arrangements for communicating timing advance group assignment information from the network node 22 to one of the mobile terminals 24. In each of these figures, the signaling values include a portion of a MAC control element 49. Although the illustrated portions may constitute an entire MAC control element, it is understood that the MAC control elements 49 are not limited to including only the illustrated portions, and may include other portions not illustrated in FIGS. 5-9. Also, referring specifically to FIG. 9, the subheader 70 is associated with the MAC control element 49e, but may or may not actually be part of the MAC control element 49e.

Referring to FIG. 5, a MAC control element 49a includes multiple octets 50, 52, each including eight bits. The first octet 50 includes a set of first indicators 54 and a reserved bit 56. Each first indicator 54 specifies whether a corresponding serving cell of their associated mobile terminal 24 is to be included in a timing advance group. The second octet 52 includes at least one second indicator 58 and a plurality of reserved bits 60. Each second indicator 58 specifies a timing advance group, and also specifies, via a defined mapping, the serving cell of the mobile terminal 24 to which the timing advance group corresponds.

The second indicators 58 may specify a timing advance group by specifying either an identifier of the timing advance group, or an identifier of a serving cell assigned to the timing advance group, for example. In the case where the second indicator 58 specifies an identifier of a serving cell, the specified serving cell may already belong to the timing advance group in question, or may be assigned to but not yet belonging to the timing advance group (as the mobile terminal 24 may have received but not yet carried out the assignment). In one example, if a first indicator 54 and second indicator 58 indicate the same serving cell, then the mobile terminal 24 includes the indicated serving cell in its own timing advance group.

Thus, in connection with creating a timing advance group assignment, the network node 22 may transmit the MAC control element 49a to instruct a mobile terminal 24 to include its serving cells in the assigned timing advance groups. Although the first octet 50 precedes the at least one second octet 52 in the MAC control element 49a, this is only an example ordering, and it is possible that the first octet 50 may follow the second octet 52, for example.

As will be explained below, the defined mapping of the MAC control element 49a links first indicators 54 in the first octet 50 to one or more second indicators 58 in the one or more second octets 52.

The first octet 50 includes a plurality of first indicators 54, each of which corresponds to a serving cell of the mobile terminal 24, and has a value that specifies whether its corresponding serving cell is to be included in a timing advance group. For the purpose of the discussion below, a value of “1” will be used to describe that a serving cell is to be included in a timing advance group assigned, and a value of “0” will be used for serving cell that is not to be included in a timing advance group. However, it is understood that these are only example values. In one example, the first indicators 54 correspond to “C-fields” as described in LTE Release 10, and only correspond to secondary serving cells (SCells). However, this is only an example, and it is possible that one of the first indicators 54 could correspond to a primary serving cell (PCell).

In one example, the first indicators 54 also specify whether their corresponding serving cell is to be activated or should remain activated for use by the mobile terminal in uplink carrier aggregation (e.g. by having a value of “1”), or indicate whether their corresponding serving cell should be deactivated for uplink carrier aggregation (e.g. by having a value of “0”). Also, although the first indicators 54 FIG. 5 are shown as being arranged in descending order, it is understood that they could be arranged in another order, such as ascending order, for example.

The subscript of each first indicator 54 indicates the serving cell to which that first indicator 54 corresponds. In the example of LTE Release 10, each subscript indicates a SCellIndex value. Thus, C₇ corresponds to a SCell having a SCellIndex value of 7, C₆ corresponds to a SCell having a SCellIndex value of 6, and so on. If the first octet 50 has first indicator values of C₇=1, C₄=1, and C₃=1, then the mobile terminal 24 would understand that each SCell 7, 4 and 3 is to be included in a corresponding timing advance group.

In the example of FIG. 5, the second octet 52 includes three two-bit second indicators 58, each specifying a timing advance group, and also specifying, via a defined mapping, the serving cell of the mobile terminal 24 to which the timing advance group corresponds. In one or more embodiments, the quantity of first indicators 54 indicating inclusion in a timing advance group is equal to the quantity of second indicators 58, and the defined mapping comprises an association between an ordering of the first indicators 54 and second indicators 58. In one example, the second indicators 58 are arranged in the same order as their corresponding the first indicators 54. In one example the second indicators 58 are arranged in an inverse order as compared to their corresponding first indicators 54 (i.e. a first of the first indicators 54 corresponds to a last of the second indicators 58).

Thus, using the example values from above, if C₇=1, C₄=1, and C₃=1, then the mobile terminal 24 include SCell 7 in TAG₇, would include SCell 4 in TAG₄, and would include SCell 3 in TAG₃. Assuming C₆=0, C₅=0, C₂=0 and C₁=0, then each SCell C₆, C₅, C₂ and C₁ would not be assigned to a timing advance group, and may also be deactivated for uplink carrier aggregation if they were previously activated for uplink carrier aggregation

It is also possible that the second indicators could include more than 2 bits. FIG. 6 illustrates an example MAC control element 49b utilizing two second octets 52a, 52b that include three-bit second indicators 58. In this example, more than one octet may be required to transmit the second indicators 58. For example, in the MAC control element 49 of FIG. 6 the first two bits of TAG₃ are included in octet 52a and the last bit of TAG₃ is included in octet 52b. Of course, these are only examples, and as discussed above, other bit lengths could be used for the second indicators 58.

Using the defined mapping discussed above, because the MAC control element 49b has three second indicators TAG₇, TAG₆ and TAG₃, we know that corresponding first indicators C₇, C₆ and C₃ indicate inclusion in a timing advance group (e.g. by having a value of “1”) and first indicators C₅, C₄, C₂ and C₁ do not indicate inclusion in a timing advance group (e.g. by having a value of “0”).

FIG. 7 illustrates portions of another MAC control element 49c used to communicate timing advance group assignment information from the base station 22 to a mobile terminal 24. The MAC control element 49c of FIG. 7 includes octets 62 and 64, and octet 62 includes at least one additional bit 56 not included in the set of first indicators 54 (shown as “P” in the octet 62). In this example, the MAC control element 49c indicates that the primary serving cell (PCell) of the mobile terminal 24 is assigned to a timing advance group identified by one of the second indicators 58 (e.g. group TAG_{P}) by setting the at least one additional bit 56 to a predefined value (e.g. a value of “1”). As in the other examples above, the second indicators 58 specify a timing advance group and also specify, via a defined mapping, the serving cell of the mobile terminal 24 to which the timing advance group corresponds.

In one or more embodiments, without the additional bit 56 indicating the predefined value, both the network node 22 and the mobile terminal 24 assume that the PCell of the mobile terminal 24 belongs to either a default timing advance group, or a specific, non-default timing advance group.

Although the additional bit 56 of FIG. 7 referencing the PCell is shown as being the last bit in the octet 62, this is only an example, and the additional bit 56 could instead be the first bit in the octet 62 (in which case the second indicator 58 referencing TAG could also be the first second indicator 58).

FIG. 8 illustrates another MAC control element 49d in which only a single octet 66 may be used to communicate the desired timing advance group assignment information. In this example, the octet 66 includes a plurality of indicators 68 that indicate whether a corresponding serving cell of the mobile terminal 24 is to be included in a timing advance group, and also includes the least one additional bit 69 that is not included in the plurality of indicators 68.

If the additional bit 69 has a predefined value (e.g. a value of “1”), the mobile terminal 24 knows to include indicated serving cells (e.g. those whose corresponding indicator 68 has a value of “1”) in a default timing advance group. In one example the default timing advance group is a timing advance group to which the mobile terminal's PCell belongs. Of course this is only an example, and other default timing advance groups could be used.

In one example, if a second octet is received having second indicators indicating timing advance groups (e.g. the octet 52, 64, etc.), then the mobile terminal ignores that subsequent octet in view of the default timing advance group indicated by the octet 66 and bit 69.

FIG. 9 illustrates an example MAC control element 49e and a subheader 70 associated with the MAC control element 49e, that are collectively used to communicate timing advance information. Although the subheader 70 is shown as being contiguous with MAC control element 49e, it is understood that this is only an example, and that other subheaders or non-subheaders (e.g. additional MAC control elements) could be included between the subheader 70 and the MAC control element 49e. In the example of FIG. 9, the MAC control element 49e includes two octets 72, 74 that resemble and operate in the same fashion as the MAC control element 49a. The subheader 70 includes reserved bits 75, bit 76, and also includes a logical channel identifier (LCID) 78. The LCID 78 is used to indicate a timing advance group assignment to the mobile terminal 24. If the LCID includes one of a first plurality of LCID values, the mobile terminal 24 includes all of its activated SCells in a timing advance group of the mobile terminal's PCell.

If, however, the LCID 78 includes one of a second plurality of LCID values, the mobile terminal 24 includes SCells identified by a set of first indicators 80 of the MAC control element 49e (see octet 72) to timing advance groups identified in one or more second indicators 82 of the MAC control element 49e (see octet 74).

In one example, the plurality of first LCID values are selected LCID values from the 3rd Generation Partnership Project (3GPP) Long Term Evolution (LTE) Release 10 (see, e.g., the tables of FIGS. 10a-b), and the second plurality of LCID values are LCID values other than the selected Release 10 LCID values (e.g. LTE Release 10 LCID values). In one example, the first plurality of LCID values includes all LCID values from FIGS. 10a-b except the “Reserved” values 01011-11010.

Although a specific defined mapping between first indicators 54 and second indicator 58 has been described (e.g. in relation to FIGS. 5-7), it is understood that this disclosed mapping is only a non-limiting example, and other defined mappings could be possible.

Also, although the network node 20 is illustrated as an eNodeB, and the mobile terminals 24a-b are illustrated as corresponding to two UEs, it is understood that these are only non-limiting examples, and those of ordinary skill in the art will appreciate that this invention is not limited to LTE wireless communication networks.

Thus, the foregoing description and the accompanying drawings represent non-limiting examples of the methods and apparatus taught herein. As such, the present invention is not limited by the foregoing description and accompanying drawings. Instead, the present invention is limited only by the following claims and their legal equivalents.

What is claimed is:

1. A method for assigning serving cells of a mobile terminal to timing advance groups, said method being performed by a network node in a wireless communication network, said method comprising:
transmitting a Medium Access Control (MAC) control element to a mobile terminal, the MAC control element comprising:
a set of first indicators, each first indicator specifying whether a corresponding serving cell of the mobile terminal is to be included in a timing advance group; and
at least one second indicator, each second indicator specifying a timing advance group, and also specifying, via a defined mapping, the serving cell of the mobile terminal to which the timing advance group corresponds.

2. The method of claim 1, wherein each of said first indicators also specifies whether its corresponding serving cell is to be activated or should remain activated for use by the mobile terminal in uplink carrier aggregation, and wherein each second indicator specifies a timing advance group by specifying either an identifier of the timing advance group or an identifier of a serving cell assigned to the timing advance group.

3. The method of claim 1, wherein the quantity of first indicators indicating inclusion in a timing advance group is equal to the quantity of second indicators, and wherein the defined mapping comprises an association between an ordering of the first and second indicators in which the second indicators are arranged in the same order as their corresponding first indicators.

4. The method of claim 1, further comprising:
transmitting an additional MAC control element to the mobile terminal, the additional MAC control element comprising:
a plurality of third indicators, each third indicator indicating whether a corresponding serving cell of the mobile terminal is part of a selection of serving cells to be included in a timing advance group; and
wherein an octet including the plurality of third indicators includes at least one additional bit not included in said plurality of third indicators, and wherein said network node assigns the selected secondary cells of the mobile terminal to a default timing advance group by setting said at least one additional bit to a predefined value.

5. The method of claim 1, wherein the set of first indicators is included in a first octet of the MAC control element and the at least one second indicator is included in one or more second octets of the MAC control element, the first octet either preceding or following the at least one second octet in the MAC control element, wherein the first octet further comprises at least one additional bit not included in said plurality of indicators, and wherein the network node assigns a primary serving cell of the mobile terminal to a timing advance group identified by one of the second indicators by setting the at least one additional bit to a predefined value.

6. A method for assigning one or more serving cells of a mobile terminal to one or more timing advance groups, said method being performed by a network node in a wireless communication network, said method comprising:
transmitting a Medium Access Control (MAC) control element and an associated subheader to the mobile terminal, the subheader including a logical channel identifier (LCID);
indicating all activated secondary serving cells of the mobile terminal as being assigned to a timing advance group of the primary serving cell of the mobile terminal by setting said LCID to include one of a first plurality of LCID values; and
indicating secondary serving cells of the mobile terminal identified by a set of first indicators of the MAC control element as being assigned to timing advance groups identified in one or more second indicators of the MAC control element by setting said LCID to include one of a second plurality of LCID values.

7. The method of claim 6, wherein said first plurality of LCID values are a selection of LCID values from the 3rd Generation Partnership Project (3GPP) Long Term Evolution (LTE) Release 10, and wherein said second plurality of LCID values are LCID values other than the selection of Release 10 LCID values.

8. A network node configured to assign one or more serving cells of a mobile terminal to one or more timing advance groups, the network node comprising:
a communication interface configured to send signals to a mobile device and to receive signals from the mobile terminal; and
one or more processing circuits operatively associated with said communication interface, and configured to transmit a Medium Access Control (MAC) control element to the mobile terminal via the communication interface, the MAC control element comprising:
a set of first indicators, each first indicator specifying whether a corresponding serving cell of the mobile terminal is to be included in a timing advance group; and
at least one second indicator, each second indicator specifying a timing advance group, and also specifying, via a defined mapping, the serving cell of the mobile terminal to which the timing advance group corresponds.

9. The network node of claim 8, wherein each of said first indicators also specifies whether its corresponding serving cell is to be activated or should remain activated for use by the mobile terminal in uplink carrier aggregation, and wherein each second indicator specifies a timing advance group by specifying either an identifier of the timing advance group or an identifier of a serving cell assigned to the timing advance group.

10. The network node of claim 8, wherein the quantity of first indicators indicating inclusion in a timing advance group is equal to the quantity of second indicators, and wherein the defined mapping comprises an association between an ordering of the first and second indicators in which the second indicators are arranged in the same order as their corresponding first indicators.

11. The network node of claim 8, wherein the one or more processing circuits of the network node are further configured to:
transmit, via the communication interface, an additional MAC control element to the mobile terminal, the additional MAC control element comprising:
a plurality of third indicators, each third indicator indicating whether a corresponding serving cell of the mobile terminal is part of a selection of serving cells to be included in a timing advance group; and
wherein an octet including the plurality of third indicators includes at least one additional bit not included in said plurality of third indicators, and wherein said processing circuits are configured to assign the selected secondary cells of the mobile terminal to a default timing advance group by setting said at least one additional bit to a predefined value.

12. The network node of claim 8, wherein the set of first indicators is included in a first octet of the MAC control element and the at least one second indicator is included in one or more second octets of the MAC control element, the first octet either preceding or following the at least one second octet in the MAC control element, wherein the first octet further comprises at least one additional bit not included in said plurality of indicators, and wherein the network node assigns a primary serving cell of the mobile terminal to a timing advance group identified by one of the second indicators by setting the at least one additional bit to a predefined value.

13. A network node configured to assign one or more serving cells of a mobile terminal to one or more timing advance groups, the network node comprising:
a communication interface configured to send signals to a mobile device and to receive signals from a mobile terminal; and
one or more processing circuits operatively associated with said communication interface, and configured to:
transmit, via the communication interface, a Medium Access Control (MAC) control element and an associated subheader to the mobile terminal, the subheader including a logical channel identifier (LCID);
indicate all activated secondary serving cells of the mobile terminal as being assigned to a timing advance group of the primary serving cell of the mobile terminal by setting said LCID to include one of a first plurality of LCID values; and
indicate secondary serving cells of the mobile terminal identified by a set of first indicators of the MAC control element as being assigned to timing advance groups identified in one or more second indicators of the MAC control element by setting said LCID to include one of a second plurality of LCID value.

14. The network node of claim 13, wherein said first plurality of LCID values are a selection of LCID values from the 3rd Generation Partnership Project (3GPP) Long Term Evolution (LTE) Release 10, and wherein said second plurality of LCID values are LCID values other than the selection of Release 10 LCID values.

15. A method implemented by a mobile terminal for determining timing advance group assignments for one or more serving cells of the mobile terminal based on signaling with a network node in a wireless communication network, said method comprising:
receiving a Medium Access Control (MAC) control element from a network node, the MAC control element comprising a set of first indicators and at least one second indicator;
determining whether serving cells of the mobile terminal are to be included in a timing advance group based the first indicator corresponding to each serving cell; and
determining a timing advance group assignment of each second indicator, the timing advance group assignment indicating a timing advance group, and also indicating, via a defined mapping, the serving cell of the mobile terminal to which the timing advance group assignment corresponds.

16. The method of claim 15, wherein each second indicator indicates a timing advance group by indicating either an identifier of the timing advance group or an identifier of a serving cell assigned to the timing advance group, and wherein said method further comprises:
activating one or more serving cells of the mobile terminal for uplink carrier activation, said one or more serving cells corresponding to serving cells that are not already activated and that are indicated as to be included in a timing advance group by said first indicators.

17. The method of claim 15, wherein the quantity of first indicators indicating inclusion in a timing advance group is equal to the quantity of second indicators, and wherein the defined mapping comprises an association between an ordering of the first and second indicators in which the second indicators are arranged in the same order as their corresponding first indicators.

18. The method of claim 15, further comprising:
receiving an additional MAC control element from the network node, the additional MAC control element comprising a plurality of third indicators, each third indicator indicating whether a corresponding serving cell of the mobile terminal is part of a selection of serving cells to be included in a timing advance group, wherein an octet including the plurality of third indicators also includes at least one additional bit; and
including the selected secondary cells of the mobile terminal in a timing advance group of the primary serving cell of the mobile terminal responsive to the least one additional bit having a predefined value.

19. The method of claim 18, wherein said at least one additional bit is a reserved bit of said octet including the plurality of third indicators, and wherein said processing circuits are further configured to ignore a timing advance group assignment in a subsequent MAC control element if the at least one additional bit has the predefined value.

20. The method of claim 15, wherein the set of first indicators is included in a first octet of the MAC control element and the at least one second indicator is included in one or more second octets of the MAC control element, the first octet either preceding or following the at least one second octet in the MAC control element, wherein the first octet further comprises at least one additional bit not included in said plurality of indicators, and wherein the mobile terminal includes its primary serving cell in a timing advance group identified by one of the second indicators responsive to the at least one additional bit having a predefined value.

21. A method implemented by a mobile terminal for determining timing advance group assignments for one or more serving cells of the mobile terminal based on signaling with a network node in a wireless communication network, said method comprising:
receiving a Medium Access Control (MAC) control element and an associated subheader from a network node, the subheader including a logical channel identifier (LCID);
including all activated secondary serving cells of the mobile terminal in a timing advance group of the primary serving cell of the mobile terminal responsive to said LCID including one of a first plurality of LCID values; and
including secondary serving cells of the mobile terminal identified by a set of first indicators of the MAC control element in timing advance groups identified in one or more second indicators of the MAC control element responsive to said LCID including one of a second plurality of LCID values.

22. The method of claim 21, wherein said first plurality of LCID values are a selection of LCID values from the 3rd Generation Partnership Project (3GPP) Long Term Evolution (LTE) Release 10, and wherein said second plurality of LCID values are LCID values other than the selection of Release 10 LCID values.

23. A mobile terminal operative to determine timing advance group assignments received from a network node in a wireless communication network, the mobile terminal comprising:
a communication interface configured to send signals to a network node and to receive signals from the network node; and
one or more processing circuits operatively associated with said communication interface, and configured to:
receive, via the communication interface, a Medium Access Control (MAC) control element from the network node, the MAC control element comprising a set of first indicators and at least one second indicator;
determine whether serving cells of the mobile terminal are to be included in a timing advance group based on each serving cell's corresponding first indicator; and
determine a timing advance group assignment of each second indicator, the timing advance group assignment indicating a timing advance group, and also indicating, via a defined mapping, the serving cell of the mobile terminal to which the timing advance group assignment corresponds.

24. The mobile terminal of claim 23, wherein each second indicator indicates a timing advance group by indicating either an identifier of the timing advance group or an identifier of a serving cell assigned to the timing advance group, and wherein said one or more processing circuits are also configured to:
activate one or more serving cells of the mobile terminal for uplink carrier aggregation, said one or more serving cells corresponding to serving cells that are not already activated and that are indicated as to be included in a timing advance group by said first indicators.

25. The mobile terminal of claim 23, wherein the quantity of first indicators indicating inclusion in a timing advance group is equal to the quantity of second indicators, and wherein the defined mapping comprises an association between an ordering of the first and second indicators in which the second indicators are arranged in the same order as their corresponding first indicators.

26. The mobile terminal of claim 23, said one or more processing circuits also being configured to:
receive, via the communication interface, an additional MAC control element from the network node, the additional MAC control element comprising a plurality of third indicators, each third indicator indicating whether a corresponding serving cell of the mobile terminal is part of a selection of serving cells to be included in a timing advance group, wherein an octet including the plurality of third indicators also includes at least one additional bit; and
include the selected secondary cells of the mobile terminal in a timing advance group of the primary serving cell of the mobile terminal responsive to the at least one additional bit having a predefined value.

27. The mobile terminal of claim 26, wherein said at least one additional bit is a reserved bit of said octet including the plurality of third indicators, and wherein said one or more processing circuits are further configured to ignore a timing advance group assignment in a subsequent MAC control element if the at least one additional bit has the predefined value.

28. The mobile terminal of claim 23, wherein the set of first indicators is included in a first octet of the MAC control element and the at least one second indicator is included in one or more second octets of the MAC control element, the first octet either preceding or following the at least one second octet in the MAC control element, wherein the first octet further comprises at least one additional bit not included in said plurality of indicators, and wherein the mobile terminal includes its primary serving cell in a timing advance group identified by one of the second indicators responsive to the at least one additional bit having a predefined value.

29. A mobile terminal operative to determine timing advance group assignments received from a network node in a wireless communication network, the mobile terminal comprising:
a communication interface configured to send signals to a network node and to receive signals from the network node; and
one or more processing circuits operatively associated with said communication interface, and configured to:
receive, via the communication interface, a Medium Access Control (MAC) control element and an associated subheader from a network node, the subheader including a logical channel identifier (LCID);
include all activated secondary serving cells of the mobile terminal in a timing advance group of the primary serving cell of the mobile terminal responsive to said LCID including one of a first plurality of LCID values; and
including secondary serving cells of the mobile terminal identified by a set of first indicators of the MAC control element in timing advance groups identified in one or more second indicators of the MAC control element responsive to said LCID including one of a second plurality of LCID values.

30. The mobile terminal of claim 29, wherein said first plurality of LCID values are a selection of LCID values from the 3rd Generation Partnership Project (3GPP) Long Term Evolution (LTE) Release 10, and wherein said second plurality of LCID values are LCID values other than the selection of Release 10 LCID values.
